(19) United States
(12) Patent Application Publication
(10) Pub. No.: US 2021/0087438 A1
(43) Pub. Date: Mar. 25, 2021

(54) ADHESIVE COMPOSITION FOR BATTERIES AND ADHESIVE MEMBER FOR BATTERIES USING SAME

(71) Applicant: TOAGOSEI CO., LTD., Tokyo (JP)

(72) Inventors: Tomoya SUGIKI, Tokyo (JP); Takahiro ITO, Aichi (JP); Makoto IMAHORI, Aichi (JP)

(21) Appl. No.: 16/961,478

(22) PCT Filed: Jan. 10, 2019
(86) PCT No.: PCT/JP2019/000451

§ 371 Date: Jul. 10, 2020

(30) Foreign Application Priority Data
Jan. 16, 2018 (JP) 2018-004648

(51) Int. Cl. C09J 123/26; C09J 11/08

(52) U.S. Cl. CPC C09J 123/26; C09J 2203/33; C09J 11/08

(57) ABSTRACT

An adhesive composition for a battery includes an acid-modified polyolefin (A) having an acidic group and/or an acid anhydride group and having a degree of acid modification of 0.001 to 0.10 mol %, and an alkoxysilyl group-containing compound (B) in an amount of 2 to 35 parts by mass relative to 100 parts by mass of the acid-modified polyolefin (A). In the adhesive composition for a battery, the component (B) can include at least one selected from the group consisting of an alkoxysilyl group-containing polyolefin (b1), an alkoxysilyl group-containing vinyl polymer (b2), and a silane coupling agent (b3).

### TECHNICAL FIELD

The present invention relates to an adhesive composition for a battery and an adhesive member for a battery using the same.

### BACKGROUND ART

In recent years, hot-melt type adhesive compositions are formed into a film shape or sheet shape, and the resulting adhesive film or sheet (hereinafter, collectively referred to as an “adhesive member”) has been used in chemical batteries, such as a lithium-ion battery and a fuel cell included in laptop computers, smartphones, tablets, automobiles and the like, and in physical batteries, such as a solar cell and a capacitor.

It is known that use of a hot-melt type adhesive composition containing an olefinic thermoplastic resin modified with an acid (hereinafter, referred to as a “acid-modified polyolefin”) as a main component provides relatively good adhesive strength for bonding a metal base material such as of iron, aluminum, titanium, other metals and alloys thereof, which is used as a base material for constituent members of the aforementioned batteries.

In particular, in a lithium-ion battery, lithium hexafluorophosphate used as an electrolyte may react with water to generate hydrofluoric acid, and in a fuel cell, an acid such as hydrofluoric acid may be generated from an electrolyte membrane which is a constituent member of the battery. Therefore, acid resistance is required.

Further, in a lithium-ion battery, durability is required against ethylene carbonate, diethyl carbonate, or the like used as a solvent of the electrolyte, and in a fuel cell in which a cooling liquid including ethylene glycol, propylene glycol, or the like are circulated in order to cool a battery that has generated heat due to power generation, durability is required against the ethylene glycol or the like (hereinafter, these durabilities are collectively referred to as “solvent resistance”).

Patent Literature 1 discloses an adhesive composition including a specific acid-modified polyolefin, a thermoplastic elastomer not modified with an acid, and a silane coupling agent having an epoxy group. This adhesive composition can obtain an adhesive strength thanks to the chemical bonding between the silane coupling agent and hydroxyl groups on the surface of the metal base material, and has excellent water resistance.

Patent Literature 2 discloses a resin composition composed of 50 to 99% by mass of a low-viscosity propylene-based basic polymer satisfying specific properties and 1 to 50% by mass of an acid-modified propylene-based elastomer satisfying specific properties, and a hot melt adhesive containing this resin composition. This adhesive has excellent adhesion to a polyolefin base material, and at the same time, has excellent adhesive strength to a metal base material.

Patent Literature 3 discloses a film-like encapsulant for an electronic device, which comprises an adhesive resin layer containing an acid-modified polyolefin resin and a silane-modified polyolefin resin in a mass ratio of 10:90 to 90:10, and a water vapor barrier resin layer that prevents or suppresses permeation of water vapor. This encapsulant has excellent adhesive properties to an adherend upon thermocompression bonding for a short time, and hardly decreases adhesive strength even under moist heat conditions and thus is excellent in moist heat resistance, and besides has high water vapor barrier properties.

### CITATION LIST

### Patent Literature

### Patent Literature 1: Japanese Patent Laid-Open No. 2011-213767

### Patent Literature 2: Japanese Patent Laid-Open No. 2013-060521

### Patent Literature 3: Japanese Patent Laid-Open No. 2014-149961

### SUMMARY OF INVENTION

### Technical Problem

However, when the adhesive compositions described in Patent Literature 1 to 3 are used to bond a metal base material that is to be used as a base material of a constituent member of a battery, they can provide excellent adhesive strength at room temperature and under moist heat conditions, but have problems in that they are inferior in the adhesive strength after immersion in an aqueous acidic solution at high temperature and the adhesive strength after immersion in a solvent at a high temperature (hereinafter, collectively referred to as “acid and solvent resistance at high temperature”).

One embodiment of the present invention has been made in view of the above circumstances, and it is an object of the present invention to provide an adhesive composition for a battery having excellent acid and solvent resistance at high temperature (95° C.) upon adhesion of a metal base material used for battery applications, and an adhesive member for a battery using the same.

### Solution to Problem

The present inventors have conducted intensive studies to solve the above-described problem, and have found an adhesive composition for a battery having excellent acid and solvent resistance at high temperature in the adhesion of a metal base material used for battery applications, and an adhesive member for a battery using the same.

The present invention includes the following embodiments.

[1] An adhesive composition for a battery, comprising an acid-modified polyolefin (A) having an acidic group and/or an acid anhydride group and having a degree of acid modification of 0.001 to 0.10 mol %, and an alkoxysilyl group-containing compound (B) in an amount of 2 to 35 parts by mass relative to 100 parts by mass of the acid-modified polyolefin (A).
[2] The adhesive composition for a battery according to [1], wherein the component (B) comprises at least one selected from the group consisting of an alkoxysilyl group-containing polyolefin (b1), an alkoxysilyl group-containing vinyl polymer (b2), and a silane coupling agent (b3).
[3] The adhesive composition for a battery according to [1] or [2], which has a melt flow rate of 1.0 to 20.0 g/10 min as measured under conditions of a temperature of 230° C. and a load of 1.96 MPa.
[4] The adhesive composition for a battery according to any one of [1] to [3], wherein the battery is a fuel cell.
[5] An adhesive member for a battery, comprising an adhesive resin layer formed by curing the adhesive composition for a battery according to any one of [1] to [4], wherein the adhesive resin layer has a 100% modulus of 10 to 20 MPa and a 300% modulus of 11 to 30 MPa, and has an elongation at break of 300 to 700%.

### Advantageous Effects of the Invention

The adhesive composition for a battery and adhesive member for a battery using the same according to the present disclosure can achieve excellent acid and solvent resistance at high temperature in bonding of a metal base material used for battery applications.

### DESCRIPTION OF EMBODIMENTS

Hereinafter, various embodiments of the technology disclosed in the present specification will be described in detail. It is noted that in the present specification, acrylate and/or methacrylate is referred to as (meth)acrylate.

A first aspect of the present invention (the adhesive composition for a battery according to the present disclosure) relates to an adhesive composition for a battery, comprising an acid-modified polyolefin (A) which has an acidic group and/or an acid anhydride group and has a degree of acid modification of 0.001 to 0.10 mol %, and an alkoxysilyl group-containing compound (B) in a specific ratio.

Hereinafter, the components (A), (B), other components, the adhesive composition for a battery and a production method thereof, the adhesive member for a battery and a production method thereof, and uses thereof will now be described.

1. Component (A)

The component (A) is an acid-modified polyolefin having an acidic group and/or an acid anhydride group and having a degree of acid modification of 0.001 to 0.10 mol %, and refers to a polyolefin modified with an acidic group-containing monomer and/or an acid anhydride group-containing monomer.

Specific examples of the acidic group include a carboxylic acid group, a sulfonic acid group, and a phosphoric acid group. Among these, a carboxylic acid group is preferable because the modification is easily performed.

Specific examples of the acid anhydride group include a carboxylic acid anhydride group, a sulfonic acid anhydride group, and a phosphoric acid anhydride group. Among these, a carboxylic acid anhydride group is preferable because the raw materials are easily available and the modification is easily performed.

As a method for the modification, a known method can be employed. Examples of the method include a method in which an acidic group-containing monomer and/or an acid anhydride group-containing monomer are melt-kneaded with a polyolefin in the presence of a radical polymerization initiator such as an organic peroxide or an aliphatic azo compound so as to perform graft-modification, and a method in which an acidic group-containing monomer and/or an acid anhydride group-containing monomer are copolymerized with an olefin.

1-1. Acidic Group-Containing Monomer

The acidic group-containing monomer serving as a raw material of the component (A) is a compound having an ethylenic double bond, a carboxylic acid group and others in the same molecule. Examples thereof may include various unsaturated monocarboxylic acid compounds and unsaturated dicarboxylic acid compounds.

Specific examples of unsaturated monocarboxylic acid compounds include unsaturated monocarboxylic acid compounds, such as acrylic acid, methacrylic acid, crotonic acid, and isocrotonic acid.

Specific examples of unsaturated dicarboxylic acid compounds include maleic acid, itaconic acid, citraconic acid, nadic acid, and endic acid.

As the acidic group-containing monomer, an unsaturated dicarboxylic acid compound is preferable, and maleic acid is particularly preferable, because the modification is easily performed.

These acidic group-containing monomers may be used singly or in combinations of two or more.

When part of the acidic group-containing monomer used for modification remains unreacted, it is preferable to use the component (A) from which the unreacted acidic group-containing monomer has been removed by a known method such as distillation under reduced pressure, in order to suppress an adverse effect on adhesive strength.

1-2. Acid Anhydride Group-Containing Monomer

The acid anhydride group-containing monomer serving as a raw material of the component (A) is a compound having an ethylenic double bond, a carboxylic acid anhydride group and others in the same molecule. Examples thereof may include an acid anhydride of the above-described unsaturated monocarboxylic acid compounds and an acid anhydride of the above-described unsaturated dicarboxylic acid compounds.

Specific examples of acid anhydrides of unsaturated monocarboxylic acid compounds include acrylic acid anhydride, methacrylic acid anhydride, crotonic acid anhydride, and isocrotonic acid anhydride.

Specific examples of acid anhydrides of unsaturated dicarboxylic acid compounds include maleic anhydride, itaconic anhydride, citraconic anhydride, nadic acid anhydride, and endic acid anhydride.

As the acid anhydride group-containing monomer, an acid anhydride of an unsaturated dicarboxylic acid compound is preferable, and maleic acid anhydride is particularly preferable, because the modification is easily performed.

These acid anhydride group-containing monomers may be used singly or in combinations of two or more.

When part of the acid anhydride group-containing monomer used for modification remains unreacted, it is preferable to use the component (A) from which the unreacted acid anhydride group-containing monomer has been removed by a known method, in order to suppress an adverse effect on adhesive strength.

1-3. Polyolefin

The polyolefin serving as a raw material of the component (A) is a polyolefin that does not have an acidic group or an acid anhydride group (hereinafter, referred to as “component (a1)”).

Specific examples of the component (a1) include polyethylene, polypropylene, a random copolymer of propylene and ethylene, a block copolymer of propylene and ethylene, a random copolymer of ethylene and an α-olefin, a block copolymer of ethylene and an α-olefin, a random copolymer of propylene and an α-olefin, and a block copolymer of propylene and an α-olefin. Examples of the α-olefin include 1-butene, isobutylene, 1-hexene, and 1-octene.

Among these, from the viewpoint of being able to improve acid and solvent resistance at high temperature, polypropylene polymers such as polypropylene, a propylene-ethylene block copolymer, a propylene-ethylene random copolymer, a propylene-α-olefin random copolymer, and a propylene-α-olefin block copolymer are preferable. Further, it is particularly preferable that the propylene unit constitutes 50% by mass or more of the polyolefin.

These components (a1) may be used singly or in combinations of two or more.

If the degree of acid modification of the component (A) is 0.001 mol % or more, the adhesive strength to a metal base material can be improved. The degree of acid modification is preferably 0.005 mol % or more, and more preferably 0.01 mol % or more. Further, if the degree of acid modification is 0.10 mol % or less, the acid and solvent resistance at high temperature can be improved, and so from that viewpoint, 0.07 mol % or less is preferable, and 0.05 mol % or less is more preferable.

The degree of acid modification of the component (A) means the ratio of the number of moles of the acidic group- and/or acid anhydride group-containing monomer grafted (or copolymerized) with the polyolefin to the number of moles of the repeating unit constituting the polyolefin, and is defined by the following expression using the acid value obtained by the measurement described below.

$$Degree of acid modification ( mol \% ) = \frac{Acid value \times ( M m + 1.008 ) \times 100}{( 1000 \times 56.1 \times V - Acid value \times Mp )}$$

Mm=molecular weight of acid anhydride group-containing monomer

Mp=molecular weight of repeating unit of polyolefin

V=valence of acidic group when the acid anhydride group-containing monomer is hydrolyzed

Acid Value Measurement Method

The acid value indicates the number of milligrams of potassium hydroxide required to neutralize the acid contained in 1 g of a sample, and is measured according to JIS K0070: 1992.

Specifically, 0.2 g of the sample to be measured is weighed and put in a conical flask equipped with a stopper, 20 mL of xylene is added, and the mixture is dissolved while heating to obtain a sample solution. Next, to this sample solution, a few drops of 1 w/v % phenolphthalein solution in ethanol are added as an indicator. Using 0.1 mol/L potassium hydroxide solution in ethanol as a titrant, titration is carried out until a pale red color lasting 10 seconds appears. The acid value is calculated according to the following expression.

Acid value (mg KOH/g)=(T×F×56.11×0.1)/W

Here, in the above calculation expression, T represents the titer (mL), F represents the factor of the titrant, and W represents the amount sampled (g).

The component (A) may be a mixture of an acid-modified polyolefin having an acidic group and/or an acid anhydride group, which is obtained as a result of modifying the unmodified component (a1) with an acidic group- and/or acid anhydride group-containing monomer, and a polyolefin containing the unmodified component (a1). Further, the component (A) may be a polyolefin mixture whose degree of acid modification has been adjusted to 0.001 to 0.10 mol % by mixing the component (a1) with an acid-modified polyolefin having an acidic group and/or an acid anhydride group and having a degree of acid modification of 0.001 to 10.0 mol %.

From the viewpoint of being able to improve acid and solvent resistance at high temperature, the propylene unit preferably constitutes 50% by mass or more, more preferably 80% by mass or more, and further preferably 90% by mass or more of the polyolefin as the component (A).

The melting point of the component (A) is preferably 100 to 200° C., and more preferably 120 to 180° C. It is preferably 100° C. or more from the viewpoint of being able to improve acid and solvent resistance at high temperature, and is preferably 200° C. or less from the viewpoint of being able to improve workability.

The melt flow rate (hereinafter, referred to as “MFR”) of the component (A), which can be appropriately set by a person skilled in the art based on the MFR, the molecular weight and the like of the component (a1), is preferably 0.1 to 30 g/10 min and more preferably 0.1 to 20 g/10 min under measurement conditions of 230° C. and 1.96 MPa. The MFR is preferably 0.1 g/10 min or more from the viewpoint of being able to improve workability, and is preferably 30 g/10 min or less from the viewpoint of being able to improve acid and solvent resistance at high temperature.

In the adhesive composition for a battery according to the present disclosure, the components (A) may be used singly or in combinations of two or more.

The content of the component (A) is, from the viewpoint of excellent acid and solvent resistance at high temperature, preferably 70 to 98% by mass, and more preferably 80 to 98% by mass relative to 100% by mass of the adhesive composition for a battery.

2. Component (B)

The component (B) is an alkoxysilyl group-containing compound. When the alkoxysilyl group is moisture-cured to cause crosslinking, acid and solvent resistance at high temperature becomes excellent.

The component (B) preferably comprises at least one selected from the group consisting of an alkoxysilyl group-containing polyolefin (hereinafter, referred to as component (b1)), an alkoxysilyl group-containing vinyl polymer (hereinafter, referred to as component (b2)), and a silane coupling agent (hereinafter, referred to as component (b3)).

When the content ratio of the component (B) is 2 to 35 parts by mass per 100 parts by mass of the component (A), acid and solvent resistance at high temperature is excellent. This content is preferably 5 to 35 parts by mass, more preferably 10 to 35 parts by mass, and particularly preferably 20 to 35 parts by mass.

Hereinafter, the component (b1), the component (b2), and the component (b3) will be described.

2-1. Component (b1)

The component (b1) is an alkoxysilyl group-containing polyolefin.

Examples of the component (b1) include an alkoxysilyl group-containing polyethylene, an alkoxysilyl group-containing polypropylene, and an alkoxysilyl group-containing polyethylene-vinyl acetate copolymer. From the viewpoint of excellent acid and solvent resistance at high temperature, an alkoxysilyl group-containing polyethylene and an alkoxysilyl group-containing polypropylene are preferable. As the alkoxysilyl group-containing polyethylene, an alkoxysilyl group-containing low density polyethylene is more preferable.

A known method can be employed as a method for producing the component (b1). Examples of the method include a method in which an unsaturated silane compound is graft-modified with the aforementioned component (a1) in the presence of a radical polymerization initiator such as an organic peroxide or an aliphatic azo compound.

The unsaturated silane compound is preferably a vinylsilane compound. Specific examples of the vinylsilane compound include vinyltrimethoxysilane, vinyltriethoxysilane, vinyltripropoxysilane, vinyltriisopropoxysilane, vinyltributoxysilane, vinyltripentyloxysilane, vinyltriphenoxysilane, vinyltribenzyloxysilane, vinyltrimethylenedioxysilane, vinyltriethylenedioxysilane, vinylpropionyloxysilane, vinyltriacetoxysilane, and vinyltricarboxysilane. These can be used singly or in combinations of two or more.

The amount of the unsaturated silane compound to be graft-modified with the component (a1) is, per 100 parts by mass of the component (a1), preferably 0.1 to 10 parts by mass, particularly preferably 0.3 to 7 parts by mass, and further preferably 0.5 to 5 parts by mass. When the amount of the unsaturated silane compound to be graft modified is within the above range, the obtained alkoxysilyl group-containing polyolefin has high acid and solvent resistance at high temperature.

The MFR of the component (b1) is preferably 0.1 to 2,000 g/10 min, and more preferably 0.1 to 1,000 g/10 min, under the measurement conditions of 230° C. and 1.96 MPa. From the viewpoint of being able to improve workability, the MFR is preferably 0.1 g/10 min or more, and from the viewpoint of being able to improve acid and solvent resistance at high temperature, the MFR is preferably 2,000 g/10 min or less.

Commercially-available products of the alkoxysilyl group-containing polyolefin include LINKRON PK500N, LINKRON HF800N, LINKRON SL800N, and LINKRON XVF600N, manufactured by Mitsubishi Chemical Corporation, for example.

2-2. Component (b2)

The component (b2) is an alkoxysilyl group-containing vinyl polymer.

The component (b2) is obtained by polymerizing an alkoxysilyl group-containing vinyl monomer such as a vinylalkoxysilane and an alkoxysilyl group-containing (meth)acrylate, and is preferably obtained by copolymerizing it with a vinyl monomer other than the alkoxysilyl group-containing vinyl monomer.

Specific examples of the vinylalkoxysilane include vinyltrimethoxysilane, vinyltriethoxysilane, and vinylmethyldimethoxysilane.

Specific examples of the alkoxysilyl group-containing (meth)acrylate include 3-(meth)acryloxypropylmethyldimethoxysilane, 3-(meth)acryloxypropyltrimethoxysilane, 3-(meth)acryloxypropylmethyldiethoxysilane, and 3-(meth)acryloxypropyltriethoxysilane.

The method for producing the component (b2) is not particularly limited so long as it can easily produce the vinyl polymer which does not include unnecessary impurities, and the component (b2) is preferably produced by solution polymerization, high-temperature continuous polymerization, or the like using the above-described alkoxysilyl group-containing vinyl monomer.

When solution polymerization is employed, generally, it is preferable to use a polymerization initiator such as hydrogen peroxide; a persulfate such as sodium persulfate, ammonium persulfate, or potassium persulfate; an organic peroxide such as hydroperoxide, dialkyl peroxide, diacyl peroxide, peroxyester, benzoyl peroxide, or lauroyl peroxide; peracetic acid or persuccinic acid; or an azo compound such as 2,2′-azobisisobutyronitrile, 2,2′-azobis(2,4-dimethylvaleronitrile), 2,2′-azobis(2-methylbutyronitrile). The content of this polymerization initiator is preferably 0.01 to 10 parts by mass when the total amount of the vinyl monomer is 100 parts by mass.

The polymerization solvent is not particularly limited as long as it can dissolve the produced copolymer. Examples thereof include: aromatic hydrocarbons such as toluene and xylene; acetic acid esters such as ethyl acetate, butyl acetate, cellosolve acetate, methyl propylene glycol acetate, carbitol acetate, methyl propylene glycol acetate, carbitol acetate, and ethyl carbitol acetate; and ketones such as acetone and methyl ethyl ketone. The content of the polymerization solvent is preferably set such that the solid content of the obtained copolymer is 10 to 90% by mass.

When the component (b2) is produced by solution polymerization, how to use the vinyl monomer is not particularly limited, but preferably, a part of the vinyl monomer is contained in the reaction system in advance to start the polymerization, and the polymerization is further performed while the remaining vinyl monomer is continuously added or intermittently added as the polymerization reaction progresses. According to this method, a component (b2) having a low polydispersity can be produced. It is noted that the polymerization temperature is selected depending on the kind of the vinyl monomer, the kind of the polymerization initiator, the decomposition temperature or half-life of the polymerization initiator, the boiling point of the polymerization solvent, and the like, but is preferably 50° C. to 120° C.

When the component (b2) is produced by high-temperature continuous polymerization, the methods disclosed in Japanese Patent Laid-Open Nos. S57-502171, S59-6207, S60-215007, and the like can be employed. An example of this method is a method in which a pressurizable reactor is filled with a solvent, and after setting to a predetermined temperature under pressure, a raw material component composed of only a vinyl monomer or a mixture of a vinyl monomer and a polymerization solvent is fed into the reactor at a constant feed rate, and an amount of reaction liquid commensurate with the amount of the raw material component fed is extracted.

When the raw material component is a mixture of a vinyl monomer and a polymerization solvent, the polymerization solvent may be the same or different from the solvent contained in advance in the reactor at the start of the reaction. The solvent and polymerization solvent may be the compounds described above as examples of the organic solvent used in the solution polymerization, or an alcohol such as ethylene glycol, diethylene glycol, propylene glycol, dipropylene glycol, and tripropylene glycol may be used or combined therewith. It is noted that the content ratio of the polymerization solvent in the raw material component is preferably 200 parts by mass or less per 100 parts by mass of the total amount of the vinyl monomer.

It is noted that the raw material component may or may not contain a polymerization initiator. When the raw material component contains a polymerization initiator, the content of the polymerization initiator is preferably 0.001 to 5 parts by mass per 100 parts by mass of the total amount of the vinyl monomer.

The polymerization temperature in the high-temperature continuous polymerization is preferably 150° C. to 350° C. If the polymerization temperature is lower than 150° C., such a problem as slow down of reaction rate may arise if the molecular weight of the resultant copolymer becomes too large. On the other hand, if the temperature exceeds 350° C., a decomposition reaction of the produced polymer may occur to tint the polymerization solution.

The pressure of the reaction system depends on the polymerization temperature and the boiling points of the vinyl monomer and the polymerization solvent that are used. This pressure may be a pressure that does not influence the polymerization reaction but can maintain the polymerization temperature. The residence time of the vinyl monomer in the reaction system is preferably 2 to 60 minutes. If this residence time is too short, unreacted vinyl monomer may remain. On the other hand, if it is too long, productivity may decrease.

According to the above-described high temperature continuous polymerization, a copolymer having a weight average molecular weight of 1,000 to 30,000 and a relatively low viscosity can be obtained. Further, it is possible to obtain a copolymer having a lower polydispersity compared with those prepared by solution polymerization. In addition, this polymerization method does not require the use of a thermal polymerization initiator, or even when a thermal polymerization initiator is used, a copolymer having a desired molecular weight can be obtained by using just a small amount, so that a high-purity copolymer containing almost no impurities that generate radical species by heat or light can be obtained.

Examples of commercial-available products of the alkoxysilyl group-containing vinyl polymer include ARUFON (registered trademark) US-6100 and ARUFON (registered trademark) US-6170, manufactured by Toagosei Co., Ltd.

2-3. Component (b3)

The component (b3) is a compound having one or more alkoxysilyl groups in one molecule.

Examples of the component (b3) include alkylalkoxysilanes, aminoalkoxysilanes, epoxyalkoxysilanes, vinylalkoxysilanes, and an alkoxysilyl group-containing (meth)acrylate.

Specific examples of alkylalkoxysilanes include methyltrimethoxysilane, dimethyldimethoxysilane, trimethylmethoxysilane, and n-propyltrimethoxysilane.

Specific examples of aminoalkoxysilanes include N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, and N-phenyl-3-aminopropyltrimethoxysilane.

Specific examples of epoxyalkoxysilanes include 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, and 3-glycidoxypropyltriethoxysilane.

Specific examples of vinylalkoxysilanes include vinyltrimethoxysilane, vinyltriethoxysilane, and vinylmethyldimethoxysilane.

Specific examples of the alkoxysilyl group-containing (meth)acrylate include 3-(meth)acryloxypropylmethyldimethoxysilane, 3-(meth)acryloxypropyltrimethoxysilane, 3-(meth)acryloxypropylmethyldiethoxysilane, and 3-(meth)acryloxypropyltriethoxysilane.

Among the components (b1) to (b3), from the viewpoint of a high compatibility with the component (A), the component (b1) is preferable. Further, from the viewpoint that excellent acid and solvent resistance at high temperature is attained at a relatively small addition amount, the component (b2) and the component (b3) are preferable. Examples of a preferable component (b3) include aminoalkoxysilanes and epoxyalkoxysilanes.

3. Other Components

The adhesive composition for a battery according to the present disclosure contains the component (A) and the component (B), but may be supplemented with various components depending on purposes.

Specific examples of other components include a curing catalyst, a styrene thermoplastic elastomer, a tackifier, an antioxidant, a hindered amine light stabilizer, an ultraviolet absorber, an antistatic agent, a flame retardant, a colorant, a dispersant, an adhesion imparting agent, a defoaming agent, a leveling agent, a plasticizer, a lubricant, and a filler.

Hereinafter, these components will be described.

It is noted that regarding the other components described below, only one of the compounds given as examples may be used, or two or more thereof may be used in combination.

3-1. Curing Catalyst

A curing catalyst can be added for the purpose of improving the moisture curability of the adhesive composition for a battery.

Examples of the curing catalyst include tin compounds, titanates, organoaluminum compounds, chelate compounds, and amine compounds.

Specific examples of tin compounds include dibutyltin dilaurate, dibutyltin diacetate, dibutyltin diacetoacetonate, dibutyltin diethyl hexanolate, dibutyltin dioctate, dibutyltin dimethyl malate, dibutyltin diethylmalate, dibutyltin dibutyl malate, dibutyltin diisooctylmalate, dibutyltin ditridecylmalate, dibutyltin dibenzylmalate, dibutyltin maleate, dioctyltin diacetate, dioctyltin distearate, dioctyltin dilaurate, dioctyltin diethylmalate, and dioctyltin diisooctylmalate.

Specific examples of titanates include tetrabutyl titanate and tetrapropyl titanate.

Specific examples of organoaluminum compounds include aluminum trisacetylacetonate, aluminum trisethylacetoacetate, and diisopropoxyaluminum ethylacetoacetate.

Specific examples of chelate compounds include zirconium tetraacetylacetonate and titanium tetraacetylacetonate.

Specific examples of amine compounds include butylamine, octylamine, laurylamine, dibutylamine, monoethanolamine, diethanolamine, triethanolamine, diethylenetriamine, triethylenetetramine, oleylamine, cyclohexylamine, benzylamine, diethylaminopropylamine, xylylenediamine, triethylenediamine, guanidine, diphenylguanidine, 2,4,6-tris(dimethylaminomethyl)phenol, morpholine, N-methylmorpholine, 2-ethyl-4-methylimidazole, and 1,8-diazabicyclo[5,4,0]undecene-7 (DBU).

Among these, organotin compounds and strong basic amine compounds such as DBU are preferable because of their high catalytic effect.

The content ratio of the curing catalyst is preferably 0.01 to 20 parts by mass per 100 parts by mass of the total solid content including the components (A) and (B). By setting the ratio of the curing catalyst to 0.01 parts by mass or more, it is easy to sufficiently obtain the catalytic effect. By setting the ratio of the curing catalyst to 20 parts by mass or less, the storage stability of the adhesive composition for a battery can be secured.

3-2. Styrene Thermoplastic Elastomer

The styrene thermoplastic elastomer can be added for the purpose of improving the adhesive strength.

Specific examples of the styrene thermoplastic elastomer include styrene resins, such as a styrene-butadiene copolymer, an epoxy-modified styrene-butadiene copolymer, a styrene-butadiene-styrene block copolymer, a styrene-ethylene/propylene-styrene block copolymer (hereinafter, referred to as “SEPS”), a styrene-ethylene/butylene-styrene block copolymer (hereinafter, referred to as “SEBS”), a styrene-isoprene/butadiene-styrene block copolymer, and a styrene-isoprene-styrene block copolymer. The styrene thermoplastic elastomer may be one having no acidic group or acid anhydride group, and may be one having an amino group.

As a modification method for introducing an acidic group and/or an acid anhydride group, a known method can be employed. Examples of the method include a method in which the acidic group- and/or acid anhydride group-containing monomer is melt-kneaded with the styrene resin in the presence of a radical polymerization initiator such as an organic peroxide or an aliphatic azo compound so as to perform graft-modification.

As a modification method for introducing an amino group, a known method can be employed. Examples of the method include terminal modification in which an amino group-containing compound is added to the living terminal of the above-described styrene resin obtained by living anionic polymerization, and a method in which an amine compound having an unsaturated bond, such as 2-(1-cyclohexenyl)ethylamine, is melt-kneaded with the styrene resin in the presence of a radical polymerization initiator such as an organic peroxide or an aliphatic azo compound so as to perform graft-modification.

Among these, SEPS and SEBS are preferable because it is possible to achieve acid and solvent resistance at high temperature as well as workability.

The acid value of the styrene thermoplastic elastomer is preferably 80 mg KOH/g or less from the viewpoint of being able to maintain stable quality. Further, from the viewpoint of being able to improve acid and solvent resistance at high temperature, the acid value is more preferably 50 mg KOH/g or less, particularly preferably 20 mg KOH/g or less, and may be 0.0 mg KOH/g.

The MFR of the styrene thermoplastic elastomer is preferably 1 to 100 g/10 min, and more preferably 1 to 90 g/10 min, under the measurement conditions of 230° C. and 1.96 MPa. From the viewpoint of being able to improve workability, the MFR is preferably 1 g/10 min or more, and from the viewpoint of being able to improve acid and solvent resistance at high temperature, the MFR is preferably 100 g/10 min or less.

Regarding the content of the styrene thermoplastic elastomer, it is preferable to comprise 80 to 90% by mass of the component (A) and 1 to 20% by mass of the styrene thermoplastic elastomer, based on the total amount of the component (A) and the styrene thermoplastic elastomer.

The content of the styrene thermoplastic elastomer is preferably 1% by mass or more from the viewpoint of excellent workability, and is preferably 20% by mass or less from the viewpoint of being able to improve acid and solvent resistance at high temperature.

3-3. Tackifier

The tackifier can be added for the purpose of improving the adhesive strength.

As the tackifier, a known tackifier can be used. Examples thereof include a polyterpene resin, a rosin resin, an aliphatic petroleum resin, an alicyclic petroleum resin, a copolymer petroleum resin, and a hydrogenated petroleum resin.

Specific examples of the polyterpene resin include an α-pinene polymer, a β-pinene polymer, and copolymers of these with phenol, bisphenol A or the like.

Specific examples of the rosin resin include a natural rosin, a polymerized rosin, and ester derivatives thereof.

Specific examples of the aliphatic petroleum resin include a resin also called a C5 resin, which is generally a resin synthesized from the C5 fraction of petroleum. The alicyclic petroleum resin, which is also called a C9 resin, is generally a resin synthesized from the C9 fraction of petroleum.

Specific examples of the copolymerized petroleum resin include a C5/C9 copolymerized resin.

Hydrogenated petroleum resins are generally produced by hydrogenation of the above-described various petroleum resins.

The content of the tackifier is, from the viewpoint of excellent acid and solvent resistance at high temperature, preferably 1 to 20% by mass, and more preferably 1 to 10% by mass per 100% by mass of the adhesive composition for a battery.

4. Adhesive Composition for a Battery

As described above, the adhesive composition for a battery according to the present disclosure includes 2 to 35 parts by mass of the component (B) per 100 parts by mass of the component (A).

The MFR of the adhesive composition for a battery according to the present disclosure can be appropriately set by a person skilled in the art based on the MFR, molecular weight and the like of the component (A), and the molecular weight, polarity and the like of the component (B). Under the measurement conditions of 230° C. and 1.96 MPa, the MFR is preferably 1.0 to 20 g/10 min, and more preferably 5 to 20 g/10 min. From the viewpoint of being able to improve workability, the MFR is preferably 1 g/10 min or more, and from the viewpoint of excellent acid and solvent resistance at high temperature, the MFR is preferably 20 g/10 min or less.

5. Method for Producing the Adhesive Composition for a Battery

A second aspect of the present invention (method for producing the adhesive composition for a battery according to the present disclosure) is a method for producing the adhesive composition for a battery. A known method can be employed for the method for producing the adhesive composition for a battery according to the present disclosure.

Specifically, the adhesive composition for a battery according to the present disclosure can be obtained in the form of pellets by undergoing a step (mixing step) of obtaining a mixture by mixing the component (A), the component (B) and optionally other components using a Henschel mixer, a Banbury mixer, a V-type blender, a tumbler blender, a ribbon blender or the like, and a step (melt-kneading step) of melt-kneading the mixture at a temperature of 180 to 300° C., and preferably 190 to 260° C., using a short-screw extruder, a multi-screw extruder, a roll, a kneader or the like.

6. Adhesive Member for a Battery

An adhesive member for a battery, which is a third aspect of the present invention (adhesive member for a battery according to the present disclosure), includes an adhesive resin layer formed by curing the above-described adhesive composition for a battery. From the viewpoint of excellent acid and solvent resistance at high temperature, the adhesive resin layer preferably has a 100% modulus of 10 to 20 MPa and a 300% modulus of 11 to 30 MPa, and has an elongation at break of 300 to 700%.

The shape of the adhesive member for a battery may be appropriately set according to the use and the like, and examples of the shape include, but are not particularly limited to, a film shape, a sheet shape, a plate shape, an angle shape, and a bar shape.

7. Method for Producing the Adhesive Member for a Battery

A fourth aspect of the present invention (method for producing the adhesive member for a battery according to the present disclosure) is a method for producing the adhesive member for a battery. The adhesive member for a battery according to the present disclosure can be produced as an adhesive member for a battery including an adhesive resin layer formed of a cure product of the above-described adhesive composition for a battery, by curing the above-described adhesive composition for a battery after or while forming it into a flat plate shape with a film forming machine.

Further, it can be produced as an adhesive member for a battery (hereinafter, referred to as “adhesive member for a battery having a metal base material”, “adhesive member for a battery having a glass base material”, or “adhesive member for a battery having a thermoplastic resin base material”) in which an adhesive resin layer formed of the adhesive composition for a battery is laminated on one side or both sides of a base material, namely, a metal base material, a glass base material, or a thermoplastic resin base material, by melt-kneading the adhesive composition at a temperature of 50° C. to 200° C. and performing extrusion molding using a T-die system, an inflation system, a calendar system, or a screw type extruder.

When the adhesive member for a battery is produced, from the viewpoint of productivity, it is preferable to use the adhesive composition for a battery which has been formed into pellets.

Examples of the metal base material include iron, aluminum, titanium, magnesium, copper, nickel, chromium, other metals, and alloys thereof. Among these, from the viewpoint of excellent acid resistance, titanium or a titanium alloy is preferable.

The thickness of the metal base material may be appropriately set according to the material, use and the like, and thus is not particularly limited.

Examples of the glass base material include alkali glass, non-alkali glass, and quartz glass.

The thickness of the glass base material may be appropriately set according to the material, use and the like, and thus is not particularly limited.

Examples of the thermoplastic resin base material include a polyolefin resin, a polyester resin, a polyamide resin, a polyacrylonitrile resin, a polyvinyl alcohol resin, and a polyvinyl chloride resin.

The thickness of the thermoplastic resin base material may be appropriately set according to the material, use and the like, and thus is not particularly limited.

The adhesive member for a battery having the above-described metal base material can be laminated to a metal base material, glass base material, or thermoplastic resin base material, and bonded thereto by heating, preferably by heating and pressing.

Further, the adhesive member for a battery having the above-described thermoplastic resin base material can be laminated to a metal base material, and bonded thereto by heating, preferably by heating and pressing.

The thickness of the adhesive resin layer may be appropriately set according to the material of the metal base material, use or the like. The thickness is not particularly limited, but is preferably 10 to 200 and more preferably 20 to 200

8. Applications

The adhesive composition for a battery and adhesive member for a battery using the same according to the present disclosure can be used in batteries in various industrial product fields, such as in the electrical field, the automotive field, the industrial production field, and other fields.

Examples of these batteries include chemical batteries and physical batteries. Examples of chemical batteries include a lithium-ion battery and a fuel cell, which can be applied to laptop computers, smartphones, tablets, automobiles, and the like. Examples of physical batteries include a solar battery and a capacitor.

Among these, from the viewpoint of a large effect produced by the present invention, the application to a lithium ion battery and a fuel cell is preferable, and the application to a fuel cell is particularly preferable.

### EXAMPLES

Hereinafter, the present invention will be specifically described based on examples. It is noted that the present invention is not limited to these examples.

### 1. Examples 1-10, Comparative Examples 1-5

1) Preparation of the Adhesive Composition for a Battery

The compounds shown in the following Table 1 were mixed in advance in the amounts of parts by mass shown in Table 1, and then charged into a twin-screw extruder with L/D=42 and ϕ=58 mm from the hopper thereof to melt-mix the composition. At this time, the barrel temperature was set to 170° C. Deaeration was performed, and the mixture was discharged in a strand shape. The discharged resin was cooled through a water tank, processed into pellets by a pelletizer, and dried in a constant temperature bath at 40° C. to prepare a pelletized adhesive composition for a battery.

Using the obtained adhesive composition for a battery, the MFR thereof was measured in accordance with the method described below. The results are shown in Table 1.

MFR Measurement Method

MFR was measured under the following conditions in accordance with JIS K7210 (1999). The results are shown in Table 1.

Device: Flow tester CFT-500 (manufactured by

### Shimadzu Corporation)

Dice: 01 mm×10 mm

### Load: 1.96 MPa

Cylinder area: 1 cm²
Cylinder temperature: 230° C.

It is noted that the numbers in Table 1 are in parts by mass.

Further, the abbreviations in Table 1 mean the following.

Polyolefin

P553A: Acid modified polypropylene (degree of acid modification: 0.015 mol %, MFR: 1.9 g/10 min, melting point: 148° C.), MODIC P553A manufactured by Mitsubishi Chemical Corporation
QF551: Acid modified polypropylene (degree of acid modification: 0.15 mol %, MFR: 5.7 g/10 min, melting point: 135° C.), ADMER QF551 manufactured by Mitsui Chemicals, Inc.
S400: Polypropylene (degree of acid modification: 0 mol %, MFR: 2,000 g/10 min, melting point: 80° C.), L-MODU S400 manufactured by Idemitsu Kosan Co., Ltd.

Alkoxysilyl Group-Containing Polyolefin

PK500N: Alkoxysilyl group-containing polypropylene (MFR: 11 g/10 min), LINKRON PK500N manufactured by Mitsubishi Chemical Corporation
HF800N: Alkoxysilyl group-containing polyethylene (MFR: 1 g/10 min), LINKRON HF800N manufactured by Mitsubishi Chemical Corporation
SL800N: Alkoxysilyl group-containing low-density polyethylene (MFR: 4 g/10 min), LINKRON SL800N manufactured by Mitsubishi Chemical Corporation

Alkoxysilyl Group-Containing Vinyl Polymer

US6100: Alkoxysilyl group-containing vinyl polymer (weight average molecular weight 2,500), ARUFON (registered trademark) US-6100 manufactured by Toagosei Co., Ltd.
US6170: Alkoxysilyl group-containing vinyl polymer (weight average molecular weight 3,000), ARUFON (registered trademark) US-6170 manufactured by Toagosei Co., Ltd.

Silane Coupling Agent

A1100: γ-Aminopropyltriethoxysilane, SILQUEST A-1100 SILANE manufactured by Momentive Performance Materials Inc.
Z6043: 2-(3,4-epoxycyclohexyl)ethyltrimethoxysilane, DOW KORNING 26043 SILANE manufactured by Dow Corning Toray Co., Ltd.

Curing Catalyst

DBTDL: Dibutyltin dilaurate, ADEKA STAB BT-11 manufactured by ADEKA Corporation

### DBU: Diazabicycloundecene

2) Production of the Adhesive Member for a Battery Using a film forming machine, the pelletized composition obtained in 1.1) above was formed into a flat plate having a thickness of 50 then allowed to stand at 80° C. and 90% RH for 24 hours, and then allowed to stand at 25° C. and 50% RH for 24 hours to undergo crosslinking, thereby producing an adhesive member for a battery.

3) Measurement of Physical Properties of the Adhesive Member for a Battery

### Tensile Properties Measurement Method

Test pieces of the adhesive member for a battery obtained in 1.2) were prepared using a dumbbell-shaped No. 3 die, and the 100% modulus, the 300% modulus and the elongation at break thereof were measured at a tensile speed of 100 ram/min in accordance with JIS K6251 (2010). The results are shown in Table 1.

4) Evaluation of the Adhesive Member for a Battery

The adhesive member for a battery obtained in 1.2) was sandwiched between two titanium foils (width 10 mm, length 50 mm, thickness 100 μm), and pressure-bonded by applying pressure from both sides of the titanium foils using a heat press machine.

The bonding conditions at this time were a temperature of 160° C., a pressure of 1 MPa, and a pressure bonding time of 10 seconds. Then, this integrated piece was aged at 25° C. for 3 days to prepare a test piece.

Acid Resistance at High Temperature

The test piece was immersed in an aqueous sulfuric acid solution (pH 2, 100 ppm of sodium fluoride added) at 95° C. for 200 hours, and then the peel strength (measurement temperature 25° C.) was measured by a T peel test (tensile speed 100 ram/min). The results are shown in Table 1. It is noted that a practical level is 2 N/mm or more.

Solvent Resistance at High Temperature

The test piece was immersed in a solution of ethylene glycol/water (50/50% by mass) at 95° C. for 200 hours, and then the peel strength (measurement temperature 25° C.) was measured by a T peel test (tensile speed: 100 ram/min). The results are shown in Table 1. It is noted that a practical level is 2 N/mm or more.

TABLE 1

| | | | | Ex- | Ex- | Ex- | Ex- | Ex- | Ex- | Ex- | Ex- | Ex- |
|---|---|---|---|---|---|---|---|---|---|---|---|---|
| | | | | ample | ample | ample | ample | ample | ample | ample | ample | ample |
| | | | | 1 | 2 | 3 | 4 | 5 | 6 | 7 | 8 | 9 |
| Adhe- | Component (A) | | P553A | 100 | 100 | 100 | 100 | 100 | 100 | 100 | 100 | 100 |
| sive | | | QF551 | | | | | | | | | |
| Com- | | | S400 | | | | | | | | | |
| position | Com- | Component | PK500N | 5 | 10 | 30 | | | | | | |
| | ponent | (b1) | HF800N | | | | 10 | | | | | |
| | (B) | | SL800N | | | | | 10 | | | | |
| | | Component | US6100 | | | | | | 5 | | | |
| | | (b2) | US6170 | | | | | | | 5 | | |
| | | Component | A1100 | | | | | | | | 3 | |
| | | (b3) | Z6043 | | | | | | | | | 3 |

| | | | | | | | | | | | |
|---|---|---|---|---|---|---|---|---|---|---|---|
| | Curing Catalyst | DBTDL | 0.05 | 0.05 | 0.05 | 0.05 | 0.05 | 0.05 | 0.05 | 0.05 | 0.05 |
| | | DBU | | | | | | | | | |
| | MFR | (g/10 min) | 1.9 | 1.9 | 1.9 | 1.9 | 1.9 | 3.0 | 3.0 | 3.5 | 3.5 |
| Adhe- | Tensile Properties | 100% | 10 | 13 | 16 | 13 | 15 | 11 | 11 | 14 | 14 |
| sive | | Modulus | | | | | | | | | |
| Resin | | 300% | 12 | 14 | 20 | 15 | 18 | 11 | 11 | 14 | 15 |
| Layer | | Modulus | | | | | | | | | |
| | | Breaking | 560 | 480 | 370 | 480 | 420 | 720 | 700 | 620 | 600 |
| | | Elongation | | | | | | | | | |
| Eval- | Acid resistance at | Peeling | 2.6 | 2.8 | 3.2 | 2.7 | 2.8 | 2.4 | 2.3 | 2.2 | 2.3 |
| uation | high temperature | Strength | | | | | | | | | |
| Results | | (N/mm) | | | | | | | | | |
| | Solvent resistance at | Peeling | 2.5 | 2.7 | 3.3 | 2.7 | 2.5 | 2.3 | 2.3 | 2.3 | 2.1 |
| | high temperature | Strength | | | | | | | | | |
| | | (N/mm) | | | | | | | | | |

| | | | | Example | Comparative | Comparative | Comparative | Comparative | Comparative |
|---|---|---|---|---|---|---|---|---|---|
| | | | | 10 | Example 1 | Example 2 | Example 3 | Example 4 | Example 5 |
| Adhe- | Component (A) | | P553A | 100 | 100 | 100 | | | |
| sive | | | QF551 | | | | 100 | | |
| Com- | | | S400 | | | | | 100 | |
| position | Com- | Component | PK500N | 10 | | 40 | 10 | 10 | 100 |
| | ponent | (b1) | HF800N | | | | | | |
| | (B) | | SL800N | | | | | | |
| | | Component | US6100 | | | | | | |
| | | (b2) | US6170 | | | | | | |
| | | Component | A1100 | | | | | | |
| | | (b3) | Z6043 | | | | | | |

| | | | | | | | | |
|---|---|---|---|---|---|---|---|---|
| | Curing Catalyst | DBTDL | | 0.05 | 0.05 | 0.05 | 0.05 | 0.05 |
| | | DBU | 0.10 | | | | | |
| | MFR | (g/10 min) | 1.9 | 1.9 | 1.9 | 6.0 | 2,000 | 13 |
| Adhe- | Tensile Properties | 100% | 13 | 9 | 22 | 27 | 9 | 35 |
| sive | | Modulus | | | | | | |
| Resin | | 300% | 15 | 10 | 35 | 43 | 10 | 51 |
| Layer | | Modulus | | | | | | |
| | | Breaking | 500 | 750 | 270 | 290 | 550 | 240 |
| | | Elongation | | | | | | |
| Eval- | Acid resistance at | Peeling | 2.7 | 1.6 | 1.2 | 1.0 | 1.5 | 1.1 |
| uation | high temperature | Strength | | | | | | |
| Results | | (N/mm) | | | | | | |
| | Solvent resistance at | Peeling | 2.7 | 1.3 | 1.0 | 0.8 | 1.3 | 0.7 |
| | high temperature | Strength | | | | | | |
| | | (N/mm) | | | | | | |

5) Evaluation Results

As is clear from the results of Examples 1 to 10, the adhesive composition for a battery according to the present disclosure had excellent acid and solvent resistance at high temperature.

In contrast, the adhesive compositions for a battery of Comparative Examples 1 to 5 had poor acid and solvent resistance at high temperature.

### INDUSTRIAL APPLICABILITY

The present invention relates to an adhesive composition for a battery having excellent acid and solvent resistance at high temperature in adhesion of a metal base material used for battery applications, which can be applied to chemical batteries, such as a lithium ion battery and a fuel cell to be incorporated in laptop computers, smartphones, tablets, automobiles and the like, as well as to physical batteries, such as a solar cell and a capacitor. Among these, the application to a lithium ion battery and a fuel cell is preferable, and the application to a fuel cell is particularly preferable.

1. An adhesive composition for a battery, comprising an acid-modified polyolefin (A) having an acidic group and/or an acid anhydride group and having a degree of acid modification of 0.001 to 0.10 mol %, and an alkoxysilyl group-containing compound (B) in an amount of 2 to 35 parts by mass relative to 100 parts by mass of the acid-modified polyolefin (A).

2. The adhesive composition for a battery according to claim 1, wherein the component (B) comprises at least one selected from the group consisting of an alkoxysilyl group-containing polyolefin (b1), an alkoxysilyl group-containing vinyl polymer (b2), and a silane coupling agent (b3).

3. The adhesive composition for a battery according to claim 1, which has a melt flow rate of 1.0 to 20.0 g/10 min as measured under conditions of a temperature of 230° C. and a load of 1.96 MPa.

4. The adhesive composition for a battery according to claim 1, wherein the battery is a fuel cell.

5. An adhesive member for a battery, comprising an adhesive resin layer formed by curing the adhesive composition for a battery according to claim 1, wherein the adhesive resin layer has a 100% modulus of 10 to 20 MPa and a 300% modulus of 11 to 30 MPa, and has an elongation at break of 300 to 700%.
